(19) United States
(12) Patent Application Publication
(10) Pub. No.: US 2026/0092497 A1
(43) Pub. Date: Apr. 2, 2026

(54) LADDER CARRYING ASSEMBLY

(71) Applicant: Eric Boeckh, Henderson, NV (US)

(72) Inventor: Eric Boeckh, Henderson, NV (US)

(21) Appl. No.: 18/904,726

(22) Filed: Oct. 2, 2024

(51) Int. Cl. E06C 7/00

(52) U.S. Cl. CPC E06C 7/00

(57) ABSTRACT

A ladder carrying assembly includes a flexible panel, a handle, and a shoulder pad. The flexible panel is designed to be wrapped around and detachably connected to a portion of a side rail of a ladder between adjacent rungs. The handle is connected to the flexible panel and designed to be positioned at an outer surface of a side rail of a ladder to permit manual carrying of a ladder. The shoulder pad is designed to be positioned at an inner surface of a side rail of a ladder to permit carrying on a shoulder of a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ladder accessories and more particularly pertains to a new ladder carrying assembly for permitting a user to more easily and comfortably carry a ladder, such as a fiberglass or metal ladder. Ladders, especially those used in commercial industries, construction, and roofing, are heavy and difficult to carry. In outdoor situations, such ladders can become very hot from exposure to the sun. With fiberglass ladders in particular, it is common for fibers to become exposed over time due to wear and tear, which can irritate the skin of a user. The new ladder carrying assembly provides both a handle for easier lifting and carrying of a ladder by hand and a shoulder pad for comfortable carrying of the ladder on the shoulder of the user, while protecting the user from exposure to hot surfaces or fiberglass fibers.

### (2) Description of Related Art Including Information Disclosed Under 37 CFR 1.97 and 1.98

The prior art relates to ladder accessories. The prior art, as best understood, does not disclose a ladder carrying assembly that includes a flexible panel, a handle, and a shoulder pad, wherein the flexible panel is designed to be wrapped around and detachably connected to a portion of a side rail of a ladder between adjacent rungs, the handle permits manual carrying of a ladder, and the shoulder pad permits carrying on a shoulder of a user.

### BRIEF SUMMARY OF THE INVENTION

An embodiment of the disclosure meets the needs presented above in a ladder carrying assembly generally comprising a flexible panel, a handle, and a shoulder pad. The flexible panel is designed to be wrapped around and detachably connected to a portion of a side rail of a ladder between adjacent rungs. The handle is connected to the flexible panel and designed to be positioned at an outer surface of a side rail of a ladder to permit manual carrying of a ladder. The shoulder pad is designed to be positioned at an inner surface of a side rail of a ladder to permit carrying on a shoulder of a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a ladder carrying assembly according to an embodiment of the disclosure.

FIG. 2 is a top perspective view of an embodiment of the disclosure.

FIG. 3 is a bottom perspective view of an embodiment of the disclosure.

FIG. 4 is a top view of an embodiment of the disclosure.

FIG. 5 is a perspective view of an embodiment of the disclosure in use.

FIG. 6 is a cross-sectional view of an embodiment of the disclosure in use.

FIG. 7 is a perspective view of an embodiment of the disclosure in use.

FIG. 8 is a perspective view of a component of an embodiment of the disclosure.

FIG. 9 is a perspective view of a component of an embodiment of the disclosure.

FIG. 10 is a perspective view of an embodiment of the disclosure in use.

FIG. 11 is a perspective view of an embodiment of the disclosure in use.

FIG. 12 is a perspective view of an embodiment of the disclosure in use.

FIG. 13 is a perspective view of an embodiment of the disclosure in use.

### DETAILED DESCRIPTION OF THE INVENTION

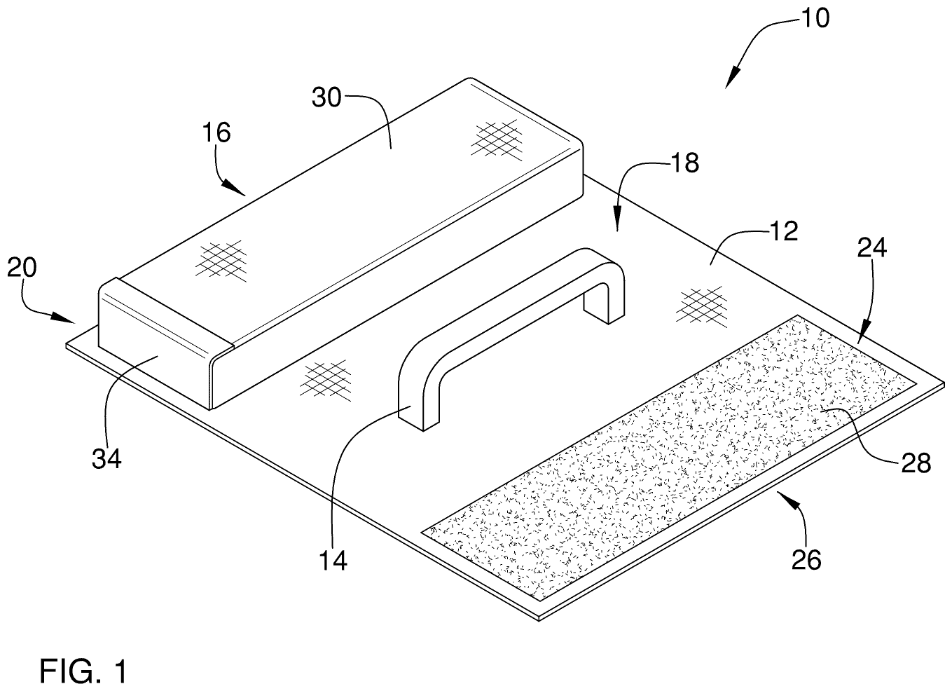

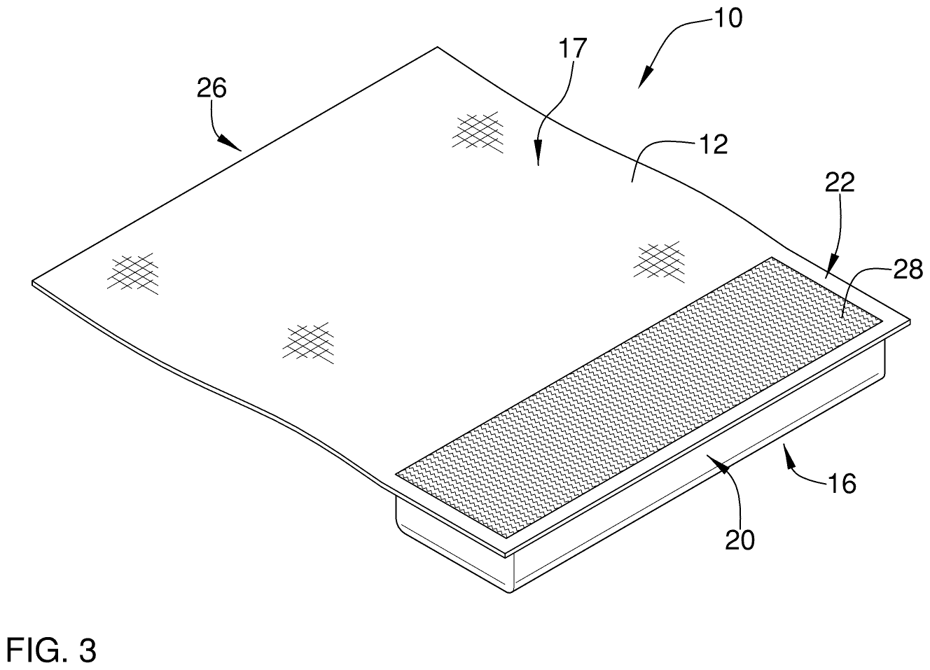

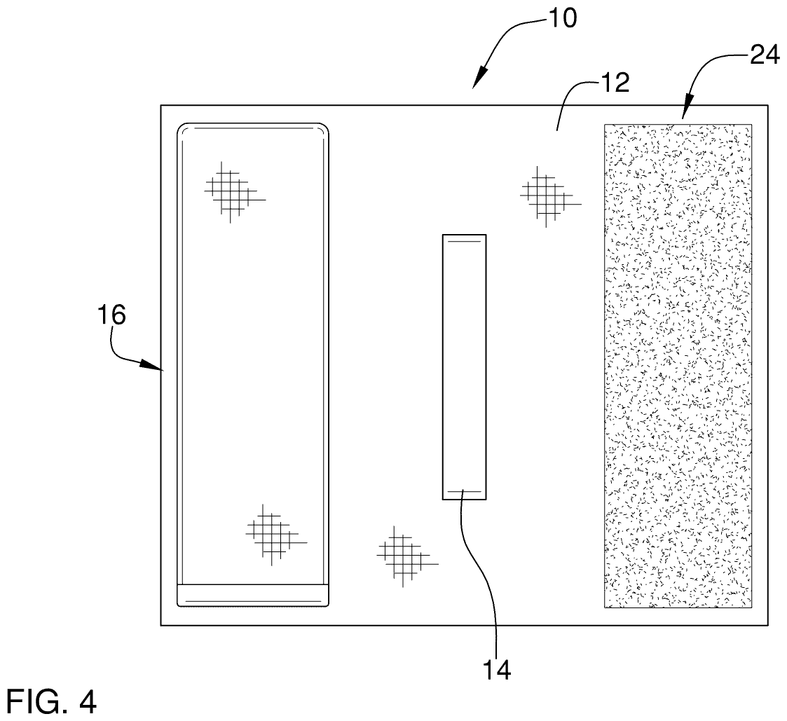

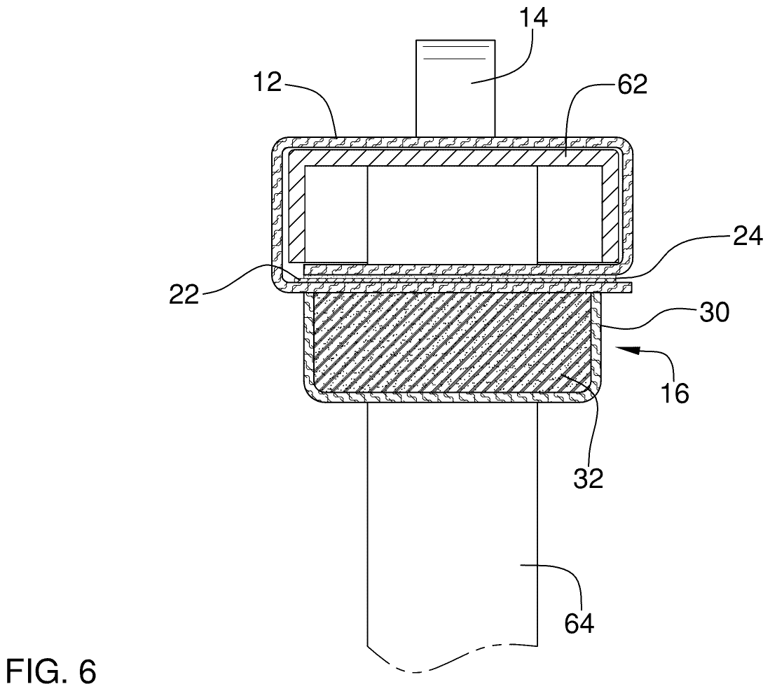

With reference now to the drawings, and in particular to FIGS. 1 through 13 thereof, a new ladder carrying assembly embodying the principles and concepts of an embodiment of the disclosure and generally designated by the reference numeral 10 will be described.

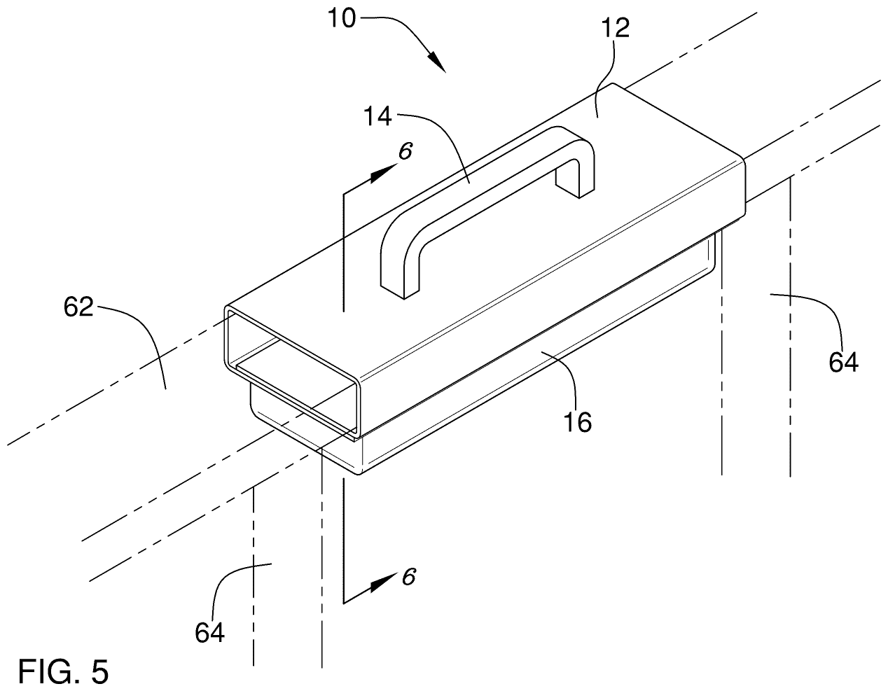

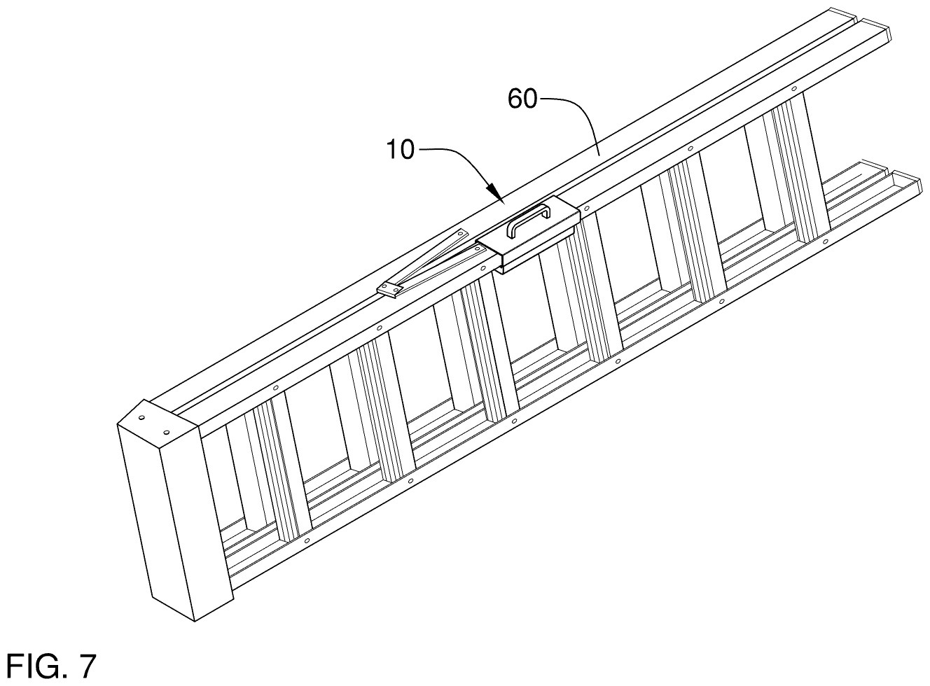

As best illustrated in FIGS. 1 through 13, the ladder carrying assembly 10 generally comprises a flexible panel 12, a handle 14, and a shoulder pad 16. The flexible panel 12 is designed to be wrapped around and detachably connected to a portion of a side rail 62 of a ladder 60 between adjacent rungs 64, as shown in FIGS. 5 and 7. The handle 14 is connected to the flexible panel 12 and designed to be positioned at an outer surface of the side rail 62 of the ladder 60 to permit manual carrying of the ladder 60.

The shoulder pad 16 is designed to be positioned at an inner surface of the side rail 62 of the ladder 60 to permit carrying on a shoulder of a user.

In the exemplary embodiment shown in FIGS. 1 through 7, the shoulder pad 16 is attached to an outer surface 18 of the flexible panel 12 at a first end 20 of the flexible panel 12. The flexible panel 12 includes a first connecting member 22 attached to an inner surface 17 of the flexible panel 12 at the first end 20 of the flexible panel 12, and a second connecting member 24 attached to the outer surface 18 of the flexible panel 12 at a second end 26 of the flexible panel 12. The first connecting member 22 is detachably connectable to the second connecting member 24 when the flexible panel 12 is wrapped around the side rail 62 of the ladder 60. Each of the first connecting member 22 and the second connecting member 24 includes a strip of hook-and-loop material 28. The handle 14 is attached to the outer surface 18 of the flexible panel 12 between the shoulder pad 16 and the first connecting member 22.

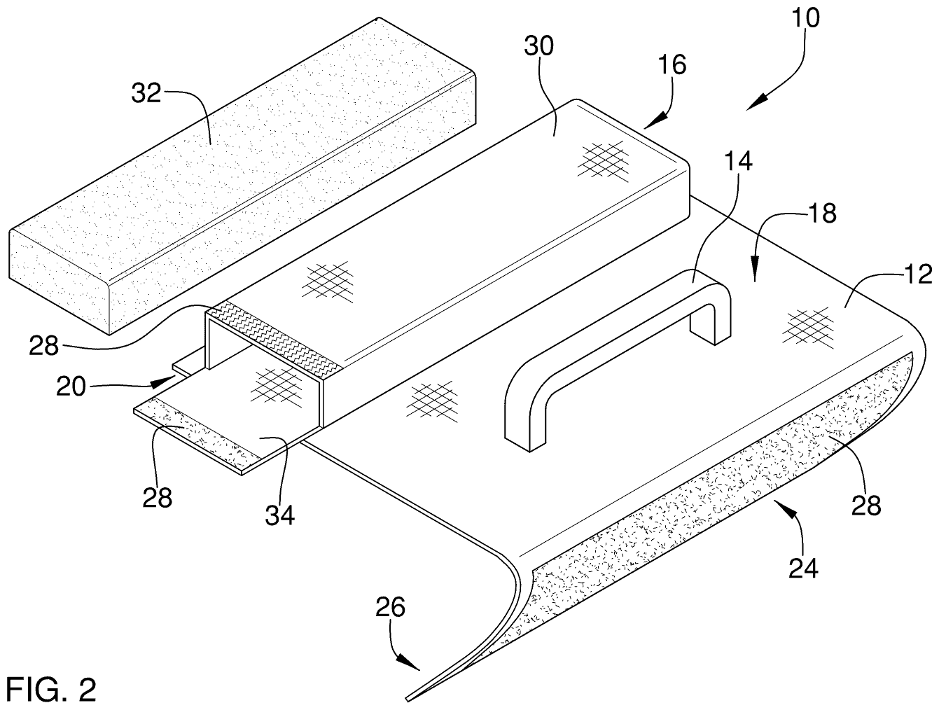

The shoulder pad 16 includes a sheath 30 attached to the flexible panel 12 and a cushion 32 removably positioned within the sheath 30, which cushion 32 could be made of memory foam or other resilient material. As shown in FIG. 2, the sheath 30 is essentially a pocket or pouch that could have a closable flap 34 that includes strips of hook-and-loop material 28.

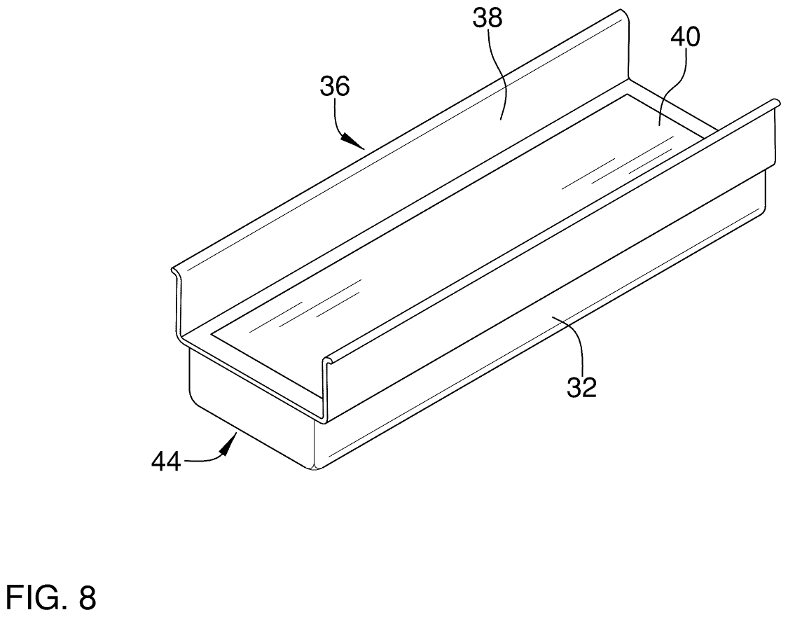

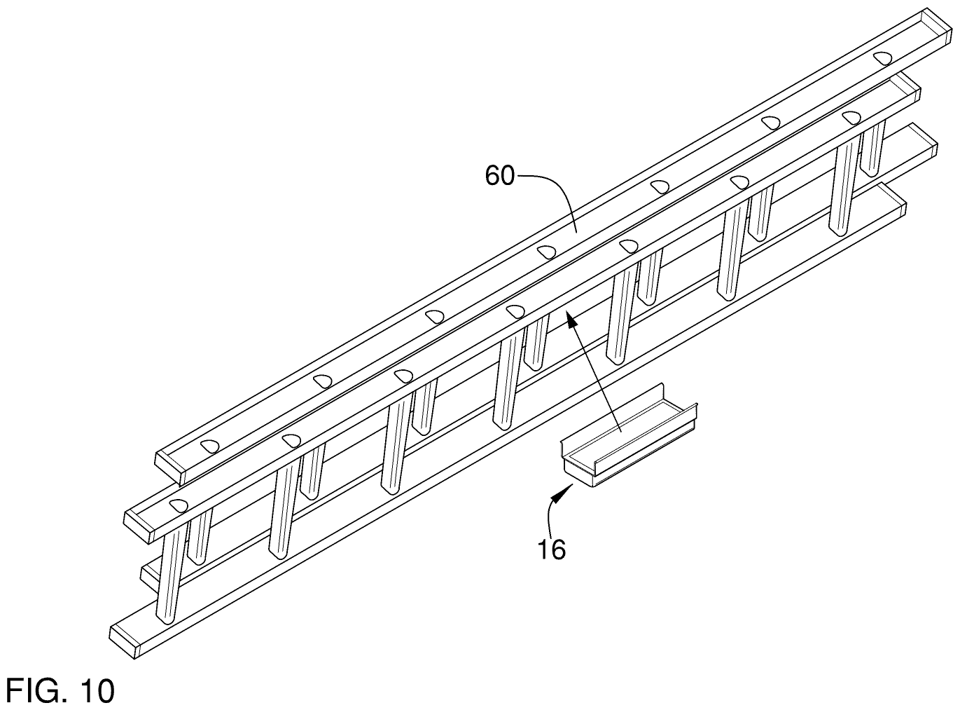

In the exemplary embodiment shown in FIG. 8, the shoulder pad 16 is separate from the flexible panel 12 and includes the cushion 32 mounted on a connecting structure 36 designed to detachably connect the cushion 32 directly to the side rail 62 of the ladder 60. The connecting structure 36 is in the form of a bracket 38 designed to snap onto the side rail 62 of the ladder 60, as shown in FIG. 10. While the bracket 38 could be designed to be sufficiently strong to hold the shoulder pad 16 in place by itself, in the exemplary embodiment shown in FIG. 8, the bracket 38 also includes a strip of adhesive material 40 designed to adhesively secure the bracket 38 to an inner surface of the side rail 62 of the ladder 60.

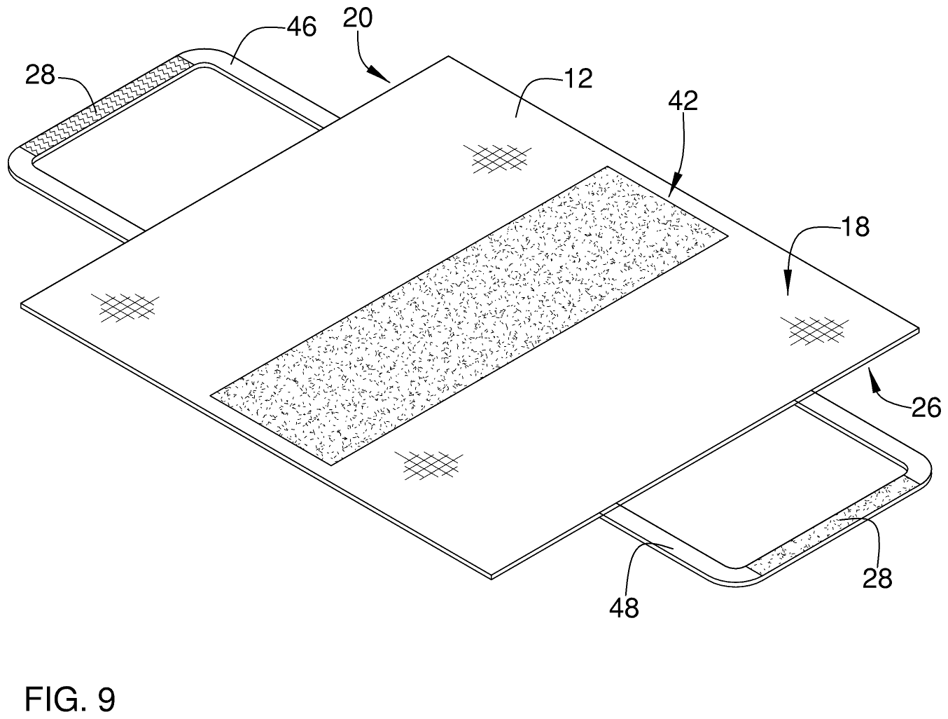

The shoulder pad 16 shown in FIG. 8 can be used by itself or in conjunction with the flexible panel 12, as shown in the exemplary embodiment in FIG. 9. The flexible panel 12 is designed to wrap around the shoulder pad 16 and hold the shoulder pad 16 against an inner surface of the side rail 62 of the ladder 60. The flexible panel 12 includes a first securing member 42 attached to the outer surface 18 of the flexible panel 12 at a central portion of the flexible panel 12, and the shoulder pad 16 includes a second securing member 44, wherein the first securing member 42 is detachably connectable to the second securing member 44 when the flexible panel 12 is wrapped around the side rail 62 of the ladder 60. Each of the first securing member 42 and the second securing member 44 includes a strip of hook-and-loop material 28.

In the exemplary embodiment shown in FIG. 9, the handle 14 includes a first handle portion 46 attached to the first end 20 of the flexible panel 12 and a second handle portion 48 attached to the second end 26 of the flexible panel 12, wherein the first handle portion 46 is detachably connectable to the second handle portion 48 to form the handle 14 upon the flexible panel 12 being wrapped around the side rail 62 of the ladder 60. In one exemplary embodiment, each of the first handle portion 46 and the second handle portion 48 is made of plastic, such as a hard plastic, and a strip of hook-and-loop material 28.

The flexible panel 12 is made of weather-resistant material. The flexible panel 12 could be made of a durable and/or waterproof material, such as a synthetic or natural fiber textile. The handle 14 could be made of a plastic material, particularly a hard plastic material, or possibly a metallic material. Regardless of the exact materials for the flexible panel 12 and the handle 14, they should be sufficiently durable to minimize wear and tear in outdoor environments, as well as sufficiently strong to permit lifting and carrying of a heavy ladder, such as a fiberglass or metal ladder, by the handle 14. It should also be noted that hook-and-loop material, i.e., Velcro®, can be used for the different detachable connections disclosed herein, though other connections, such as, but not limited to, zippers, snaps, clasps, and buttons, could be used.

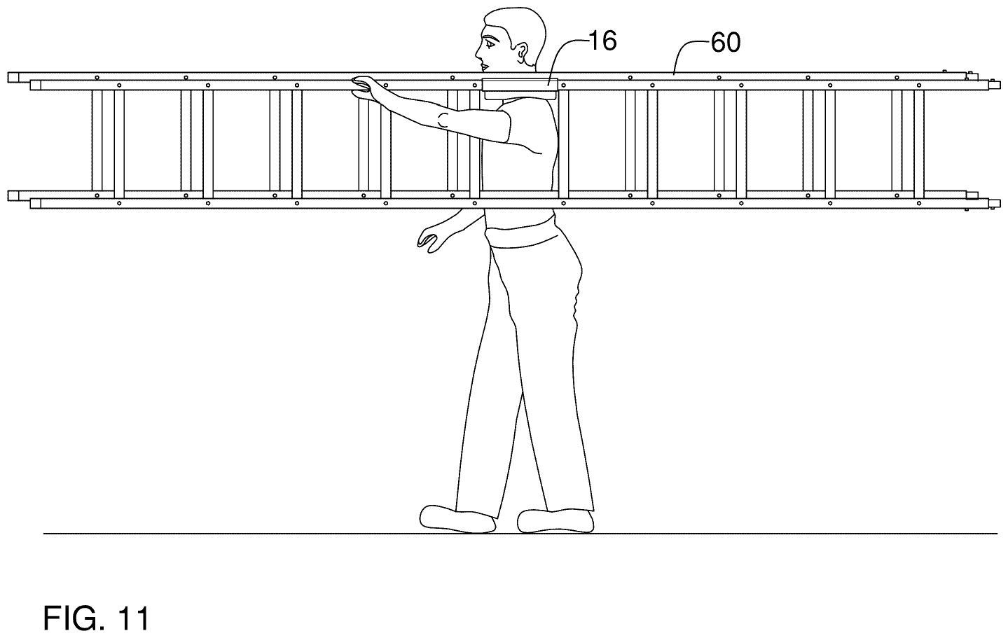

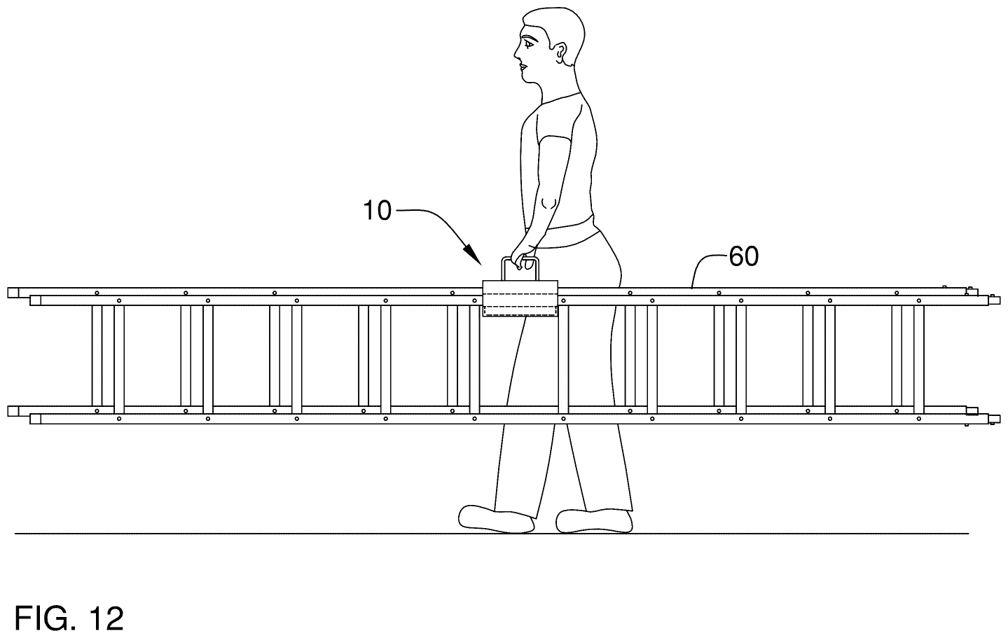

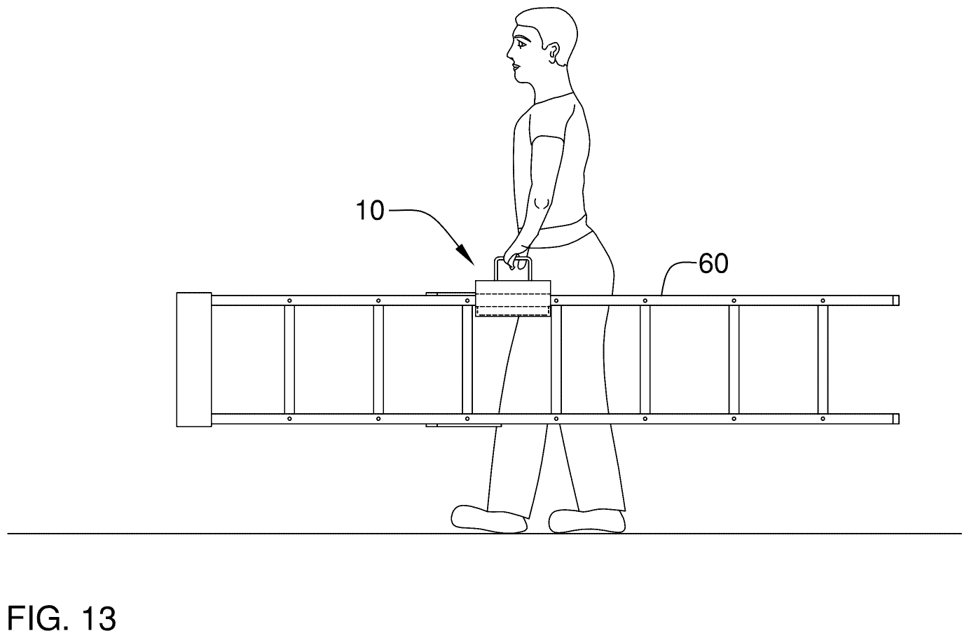

The uses of the ladder carrying assembly 10 are shown in FIGS. 11, 12, and 13 and are applicable to any of the embodiments disclosed herein. FIG. 11 shows that a user can rest the shoulder pad 16 on his shoulder to support the ladder 60 for comfortable carrying and less stress on hands and arms. The shoulder pad 16 also allows for comfortable lifting of the ladder 60 using the hands or forearms. FIGS. 12 and 13 show that a user can manually carry the ladder 60 like a briefcase using the handle 14. For the exemplary embodiment that includes both the shoulder pad 16 and the handle 14, the user advantageously has two options for lifting and carrying the ladder 60. FIGS. 12 and 13 also show that the ladder carrying assembly 10 can be used with any type of ladder 60, such as an extension ladder, as shown in FIG. 12, or an A-frame ladder or stepladder, as shown in FIG. 13.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ladder carrying assembly comprising:
a flexible panel configured to be wrapped around and detachably connected to a portion of a side rail of a ladder between adjacent rungs;
a handle connected to said flexible panel and configured to be positioned at an outer surface of a side rail of a ladder to permit manual carrying of a ladder; and
a shoulder pad configured to be positioned at an inner surface of a side rail of a ladder to permit carrying on a shoulder of a user.

2. The ladder carrying assembly of claim 1, wherein:
said shoulder pad is attached to an outer surface of said flexible panel at a first end of said flexible panel;
said flexible panel comprises a first connecting member attached to an inner surface of said flexible panel at said first end of said flexible panel, and a second connecting member attached to said outer surface of said flexible panel at a second end of said flexible panel, wherein said first connecting member is detachably connectable to said second connecting member when said flexible panel is wrapped around a side rail of a ladder; and
said handle is attached to said outer surface of said flexible panel between said shoulder pad and said first connecting member.

3. The ladder carrying assembly of claim 2, wherein said shoulder pad comprises a sheath attached to said flexible panel and a cushion removably disposed within said sheath.

4. The ladder carrying assembly of claim 3, wherein each of said first connecting member and said second connecting member comprises a strip of hook-and-loop material.

5. The ladder carrying assembly of claim 2, wherein each of said first connecting member and said second connecting member comprises a strip of hook-and-loop material.

6. The ladder carrying assembly of claim 2, wherein said flexible panel is made of weather-resistant material.

7. The ladder carrying assembly of claim 2, wherein:
said shoulder pad comprises a sheath attached to said flexible panel and a cushion removably disposed within said sheath;
each of said first connecting member and said second connecting member comprises a strip of hook-and-loop material; and
said flexible panel is made of weather-resistant material.

8. The ladder carrying assembly of claim 1, wherein said flexible panel is configured to wrap around said shoulder pad and hold said shoulder pad against an inner surface of a side rail of a ladder.

9. The ladder carrying assembly of claim 8, wherein said shoulder pad is separate from said flexible panel and comprises a cushion mounted on a connecting structure configured to detachably connect said cushion directly to a side rail of a ladder.

10. The ladder carrying assembly of claim 9, wherein said connecting structure comprises a bracket configured to snap onto a side rail of a ladder.

11. The ladder carrying assembly of claim 10, wherein said bracket comprises a strip of adhesive material configured to adhesively secure said bracket to an inner surface of a side rail of a ladder.

12. The ladder carrying assembly of claim 9, wherein said handle comprises a first handle portion attached to a first end of said flexible panel and a second handle portion attached to a second end of said flexible panel, wherein said first handle portion is detachably connectable to said second handle portion to form said handle upon said flexible panel being wrapped around a side rail of a ladder.

13. The ladder carrying assembly of claim 12, wherein each of said first handle portion and said second handle portion comprises plastic and a strip of hook-and-loop material.

14. The ladder carrying assembly of claim 9, wherein said flexible panel comprises a first securing member attached to an outer surface of said flexible panel at a central portion of said flexible panel, and said shoulder pad comprises a second securing member, wherein said first securing member is detachably connectable to said second securing member when said flexible panel is wrapped around a side rail of a ladder.

15. The ladder carrying assembly of claim 14, wherein each of said first securing member and said second securing member comprises a strip of hook-and-loop material.

16. The ladder carrying assembly of claim 9, wherein:
said flexible panel is made of weather-resistant material;
said connecting structure comprises a bracket configured to snap onto a side rail of a ladder;
said bracket comprises a strip of adhesive material configured to adhesively secure said bracket to an inner surface of a side rail of a ladder;
said handle comprises a first handle portion attached to a first end of said flexible panel and a second handle portion attached to a second end of said flexible panel, wherein said first handle portion is detachably connectable to said second handle portion to form said handle upon said flexible panel being wrapped around a side rail of a ladder;
each of said first handle portion and said second handle portion comprises plastic and a strip of hook-and-loop material;
said flexible panel comprises a first securing member attached to an outer surface of said flexible panel at a central portion of said flexible panel, and said shoulder pad comprises a second securing member, wherein said first securing member is detachably connectable to said second securing member when said flexible panel is wrapped around a side rail of a ladder; and
each of said first securing member and said second securing member comprises a strip of hook-and-loop material.

17. A ladder carrying assembly comprising a shoulder pad configured to be positioned at an inner surface of a side rail of a ladder to permit carrying on a shoulder of a user, wherein said shoulder pad comprises a cushion mounted on a connecting structure configured to detachably connect said cushion directly to a side rail of a ladder.

18. The ladder carrying assembly of claim 17, wherein said connecting structure comprises a bracket configured to snap onto a side rail of a ladder.

19. The ladder carrying assembly of claim 18, wherein said bracket comprises a strip of adhesive material configured to adhesively secure said bracket to an inner surface of a side rail of a ladder.
